(19) United States
(12) Patent Application Publication
(10) Pub. No.: US 2025/0197622 A1
(43) Pub. Date: Jun. 19, 2025

(54) PVC SLURRY FOR MANUFACTURING PVC ARTIFICIAL LEATHER, AND PVC ARTIFICIAL LEATHER

(71) Applicant: Benecke-Kaliko AG, Hannover (DE)

(72) Inventors: Ying Zhou, Zhangjiagang (CN); Yao Ma, Zhangjiagang (CN); Chengbo Lian, Jingang (CN)

(73) Assignee: Benecke-Kaliko AG, Hannover (DE)

(21) Appl. No.: 18/848,444

(22) PCT Filed: Mar. 8, 2023
(86) PCT No.: PCT/EP2023/055939

§ 371 Date: Sep. 18, 2024

(30) Foreign Application Priority Data
Mar. 18, 2022 (CN) 202210270533.6

(51) Int. Cl. C08L 27/06; D06N 3/00; D06N 3/06

(52) U.S. Cl. CPC C08L 27/06; D06N 3/0097; D06N 3/06; C08L 2203/16; C08L 2205/025; C08L 2205/03; C08L 2205/06; D06N 2205/02

(57) ABSTRACT

A PVC slurry for manufacturing a PVC artificial leather, comprising a PVC resin, a plasticizer, a viscosity reducer, and a stabilizer, wherein the viscosity reducer comprises a wetting dispersant and an aliphatic hydrocarbon solvent with a boiling point in the range of 100° C.-250° C. is disclosed. The PVC slurry further relates to a PVC artificial leather, comprising a PVC skin layer prepared from the PVC slurry of the present invention.

### BRIEF SUMMARY

The present invention relates to a PVC slurry for manufacturing a PVC artificial leather, and a PVC artificial leather prepared therefrom, which are especially suitable for use in the automotive interior trim industry.

Polyvinyl chloride (PVC) is the main raw material in the production and development of artificial leather, with PVC artificial leather being widely used in the interior trim of motor vehicles. In recent years, the development of the industrial economy has been significantly impacted by the effects of the coronavirus epidemic; as a reflection of this, the supply of raw materials is unstable and prices have risen, severely impacting product costs and stability of supply. Therefore, it is vital to develop diversified raw materials. PVC resin is the main component of PVC slurry, so the diversification of PVC resin types has far-reaching significance in the control of the overall performance and quality of products, and the creation of market value.

PVC slurry is generally worked and made into a skin by a scrape coating process, in which the viscosity of the PVC slurry is a key index that directly determines the process feasibility. In the prior art, low-viscosity and high-viscosity PVC resins are commonly used in combination to balance the viscosity. PVC slurries based completely on high-viscosity PVC resins cannot be used very effectively due to the problem of high slurry viscosity, but some high-viscosity PVC resins have favorable properties, e.g. high weather resistance and low bubble content. Thus, there is a pressing need to search for a PVC layer formula based solely on high-viscosity PVC resin, to help control costs and elevate product performance.

The key to successful use of high-viscosity PVC resin lies in reducing the viscosity of the PVC slurry. In conventional schemes for reducing the viscosity of PVC slurry, organic solvents such as toluene and cyclohexanone are used. Although these organic solvents can effectively reduce the viscosity of the slurry, residues of solvent in the finished product will affect its odor. Also, some reagents, such as aromatic solvents, are highly toxic. Thus, it is necessary to choose a suitable solvent that will reduce viscosity without causing an odor problem.

In addition, if the solvent is poorly compatible with the resin, the system will be unstable or the viscosity will be too low after viscosity reduction of the PVC slurry with the solvent; as a result, the PVC slurry will experience settlement and thus separate into layers if left standing for a long time. Furthermore, to achieve a decorative effect in the interior trim of motor vehicles, various coloring pastes are added to the PVC slurry, but coloring powders in some coloring pastes cause a sharp increase in the viscosity of the PVC slurry due to their own particle size, electric charge and functional groups, causing difficulties in real applications. In this case, more solvent needs to be added to solve the problem of the increase in viscosity caused by the coloring paste, but this will result in an odor problem due to solvent residue. Thus, when reducing the viscosity of PVC slurries, system stability and the effects of coloring pastes also need to be taken into account.

Although many schemes for reducing the viscosity of PVC slurries are known in the prior art, they are not directed at PVC slurries based on high-viscosity PVC resins, so do not enable the effective use of high-viscosity PVC resins. Thus, the selection of a suitable added component to realize real application of a high-viscosity PVC resin while ensuring basic properties of a product such as odor, heat resistance and stability is a challenging task.

For this reason, the present invention needs to propose a new technical solution to solve at least one of the many technical problems mentioned above.

Based on the prior art mentioned above, an objective of the present invention is to effectively reduce the viscosity of a PVC slurry, especially one whose production is based on a high-viscosity PVC resin, while maintaining system stability and without affecting other key properties of a finished product, so that the slurry is suitable for use in preparing PVC artificial leather for the automotive interior trim industry.

In order to achieve the abovementioned technical objective, the present invention proposes a PVC slurry for manufacturing a PVC artificial leather, the slurry comprising a PVC resin, a plasticizer, a viscosity reducer and a stabilizer, wherein the viscosity reducer comprises a wetting dispersant and an aliphatic hydrocarbon solvent with a boiling point in the range of 100° C.-250° C.

The applicant inadvertently discovered through much experimentation and research that when used in combination as a viscosity reducer, a wetting dispersant and an aliphatic hydrocarbon solvent with a boiling point of 100° C.-250° C. can maintain low odor and thermal stability in the finished product and increase the system stability of the PVC slurry while effectively reducing the viscosity of the PVC slurry, thus successfully enabling the use of high-viscosity PVC resin in PVC artificial leather in any proportion; furthermore, in the case where pigment might be added to the PVC slurry, the problems of increased PVC slurry viscosity and colour separation/mottling caused by the pigment are suppressed.

If the boiling point of the aliphatic hydrocarbon is too high, there will be a residue of aliphatic hydrocarbon in the PVC skin, which will affect the odor; if the boiling point of the aliphatic hydrocarbon is too low, it will volatilize easily and thus produce pores, resulting in product defects in the skin, and the viscosity reduction effect cannot be achieved.

When the term “boiling point” is mentioned in the present invention, it may refer to a boiling point as a temperature point value for a single substance, or a boiling range as a temperature interval for a mixture. This will be easily understood by a person skilled in the art.

According to the present invention, the PVC resin comprises a high-viscosity PVC resin with a degree of polymerization of 1300-1600 and a particle size of 1-10 μm, or consists of the high-viscosity PVC resin. Due to its high viscosity, a PVC resin falling within this range of degrees of polymerization and particle sizes generally cannot be used to prepare a PVC artificial leather successfully. In the PVC slurry formula according to the present invention, the addition of a viscosity reducer blended from an aliphatic hydrocarbon solvent with a boiling point of 100° C.-250° C. and a wetting dispersant efficiently reduces the viscosity of a slurry based on the high-viscosity PVC resin, so that the slurry can be used to prepare a PVC artificial leather successfully. The present invention is suitable even if the high-viscosity PVC resin is the only PVC resin used in the PVC slurry; in other words, there is no need to add another PVC resin to the PVC slurry of the present invention as a complement to the high-viscosity PVC resin to balance the viscosity.

Preferably, the PVC slurry comprises 30-60 parts by weight of PVC resin and 30-60 parts by weight of plasticizer, wherein the ratio of contents of the PVC resin and plasticizer is in the range of 1:2-2:1. Preferably, the plasticizer is one or more of trimellitate, a phthalate plasticizer, a fatty acid ester plasticizer and epoxidized soybean oil.

Preferably, based on the total weight of the PVC resin and plasticizer being 100 parts by weight, the PVC slurry comprises 2-10 parts by weight of viscosity reducer. Further preferably, based on the total weight of the PVC resin and plasticizer being 100 parts by weight, the viscosity reducer comprises 1-8 parts by weight of the aliphatic hydrocarbon solvent and 0.5-2 parts by weight of the wetting dispersant.

Preferably, the wetting dispersant is a carboxylate derivative. Further preferably, the carboxylate derivative is one or more of a polyester dispersant, an acrylate copolymer and a polyurethane dispersant. The wetting dispersant helps to achieve the effects of viscosity reduction and system stabilization, and can increase pigment dispersion if coloring paste is added.

Preferably, the aliphatic hydrocarbon solvent is one or more of an alicyclic hydrocarbon with a chain length of C8-C13, a branched aliphatic hydrocarbon with a chain length of C8-C13 and a straight-chain aliphatic hydrocarbon with a chain length of C8-C13. Aliphatic hydrocarbon solvents of this type may for example be one or more of solvent oils with trade names of D30, D40, D60, D80, Isopar E, Isopar G, Isopar H, Isopar L and Isopar M. Aliphatic hydrocarbon solvents of this type with a boiling point or boiling range of 100° C.-250° C. are relatively environmentally friendly solvents capable of effectively reducing the viscosity of plasticizer, while also being able to meet the odor requirements of PVC artificial leather finished products.

Preferably, based on the total weight of the PVC resin and plasticizer being 100 parts by weight, the PVC slurry comprises 1-10 parts by weight of stabilizer. The stabilizer is preferably one or more of a benzotriazole UV absorber, zinc stearate, magnesium stearate, calcium stearate, phosphite ester, pentaerythritol, xylitol and mannitol.

Preferably, based on the total weight of the PVC resin and plasticizer being 100 parts by weight, the PVC slurry comprises 1-5 parts by weight of coloring paste. The coloring paste is for example one or more of carbon black, titanium white powder and ferric oxide coloring pastes. Even though coloring paste is added, an increase in viscosity due to the coloring paste can be effectively suppressed because the wetting dispersant is included in the viscosity reducer formula of the present invention.

The PVC slurry according to the present invention, in particular the PVC slurry based on a high-viscosity PVC resin, can be used to prepare a PVC artificial leather successfully, and is especially suitable for use in interior trim materials for motor vehicles.

Correspondingly, the present invention further proposes a PVC artificial leather, comprising a PVC skin layer prepared from the PVC slurry according to the present invention. The PVC artificial leather obtained in this way is especially suitable for use as an interior trim material for motor vehicles.

Compared with a conventional PVC slurry formula, the PVC slurry of the present invention has the following advantages: the use of the aliphatic hydrocarbon solvent with a boiling point of 100° C.-250° C. and the wetting dispersant in combination can effectively reduce the viscosity of the PVC slurry based on the high-viscosity PVC resin, and maintain stability of the slurry during production, without affecting the odor or thermal aging performance of the PVC artificial leather finished product, thus making it possible to increase the proportion of high-viscosity PVC resin used, or even use the high-viscosity PVC resin alone, in the PVC slurry.

### DETAILED DESCRIPTION

To enable those skilled in the art to better understand the technical solution of the present invention, the technical solution of the present invention is described clearly and completely below in conjunction with examples and comparative examples. Obviously, the examples described are some, not all, of the examples of the present invention. All other examples obtained by a person skilled in the art based on the examples of the present invention without making creative efforts shall fall within the scope of protection of the present invention.

### Example 1

A PVC skin is prepared according to the following steps:
1) Preparation of PVC slurry: 50 parts by weight of PVC resin (degree of polymerization 1300, particle size 1-5 μm), 1 part by weight of stabilizer (calcium stearate), 50 parts by weight of plasticizer (trioctyl trimellitate), 5 parts by weight of aliphatic hydrocarbon (Isopar E, purchased from ExxonMobil, boiling range 114° C.-139° C.), 2 parts by weight of wetting dispersant (polyester) and 2 parts by weight of coloring paste (carbon black: titanium white=1:3) are mixed and stirred for 40 min, then vacuumized for 10 min, then stirred for a further 10 min under vacuumized conditions, thus obtaining the PVC slurry.
2) Preparation of PVC skin: the PVC slurry prepared in step 1) is spread onto release paper, baked for 2 min in oven conditions of 220° C. and 1500 rpm, and after cooling, a skin is peeled off the release paper, thus obtaining the PVC skin.

### Example 2

A PVC skin is prepared according to the following steps:
1) Preparation of PVC slurry: 20 parts by weight of PVC resin (degree of polymerization 1000, particle size 20-40 μm), 30 parts by weight of of PVC resin (degree of polymerization 1500, particle size 2-10 μm), 5 parts by weight of stabilizer (zinc stearate, BHT), 50 parts by weight of plasticizer (trioctyl trimellitate: ESBO=5:1), 3 parts by weight of aliphatic hydrocarbon (Isopar E, purchased from ExxonMobil, boiling range 114° C.-139° C.), 1 part by weight of wetting dispersant (polyester) and 2 parts by weight of coloring paste (carbon black: titanium white=1:1) are mixed and stirred for 40 min, then vacuumized for 10 min, then stirred for a further 10 min under vacuumized conditions, thus obtaining the PVC slurry.
2) Preparation of PVC skin: the PVC slurry prepared in step 1) is spread onto release paper, baked for 2 min in oven conditions of 220° C. and 1500 rpm, and after cooling, a skin is peeled off the release paper, thus obtaining the PVC skin.

### Example 3

A PVC skin is prepared according to the following steps:
1) Preparation of PVC slurry: 30 parts by weight of PVC resin (degree of polymerization 1400, particle size 2-5 μm), 5 parts by weight of stabilizer (benzotriazole UV absorber and zinc stearate), 60 parts by weight of plasticizer (phthalate plasticizer), 1.5 parts by weight of aliphatic hydrocarbon (Isopar G, purchased from ExxonMobil, boiling range 167° C.-176° C.), 0.5 part by weight of wetting dispersant (acrylate copolymer) and 2 parts by weight of coloring paste (carbon black: titanium white=3:1) are mixed and stirred for 40 min, then vacuumized for 10 min, then stirred for a further 10 min under vacuumized conditions, thus obtaining the PVC slurry.
2) Preparation of PVC skin: the PVC slurry prepared in step 1) is spread onto release paper, baked for 2 min in oven conditions of 220° C. and 1500 rpm, and after cooling, a skin is peeled off the release paper, thus obtaining the PVC skin.

### Example 4

A PVC skin is prepared according to the following steps:
1) Preparation of PVC slurry: 50 parts by weight of PVC resin (degree of polymerization 1500, particle size 3-8 μm), 1 part by weight of stabilizer (benzotriazole UV absorber, BHT), 50 parts by weight of plasticizer (fatty acid ester plasticizer), 5 parts by weight of aliphatic hydrocarbon (Isopar H, purchased from ExxonMobil, boiling range 179° C.-188° C.), 2 parts by weight of wetting dispersant (acrylate copolymer) and 5 parts by weight of coloring paste (carbon black: iron oxide red=1:1) are mixed and stirred for 40 min, then vacuumized for 10 min, then stirred for a further 10 min under vacuumized conditions, thus obtaining the PVC slurry.
2) Preparation of PVC skin: the PVC slurry prepared in step 1) is spread onto release paper, baked for 2 min in oven conditions of 220° C. and 1500 rpm, and after cooling, a skin is peeled off the release paper, thus obtaining the PVC skin.

### Example 5

A PVC skin is prepared according to the following steps:
1) Preparation of PVC slurry: 60 parts by weight of PVC resin (degree of polymerization 1600, particle size 1-5 μm), 9 parts by weight of stabilizer (zinc stearate, phosphite ester), 30 parts by weight of plasticizer (epoxidized soybean oil), 7 parts by weight of aliphatic hydrocarbon (Isopar L, purchased from ExxonMobil, boiling range 185° C.-199° C.), 1.5 parts by weight of wetting dispersant (polyurethane) and 2 parts by weight of coloring paste (carbon black: iron oxide red=1:1) are mixed and stirred for 40 min, then vacuumized for 10 min, then stirred for a further 10 min under vacuumized conditions, thus obtaining the PVC slurry.
2) Preparation of PVC skin: the PVC slurry prepared in step 1) is spread onto release paper, baked for 2 min in oven conditions of 220° C. and 1500 rpm, and after cooling, a skin is peeled off the release paper, thus obtaining the PVC skin.

### Example 6

A PVC skin is prepared according to the following steps:
1) Preparation of PVC slurry: 50 parts by weight of PVC resin (degree of polymerization 1500, particle size 1-5 μm), 2 parts by weight of stabilizer (pentaerythritol), 60 parts by weight of plasticizer (trioctyl trimellitate: ESBO=5:1), 3 parts by weight of aliphatic hydrocarbon (Isopar M, purchased from ExxonMobil, boiling range 200° C.-250° C.), 1 part by weight of wetting dispersant (polyester) and 1.5 parts by weight of coloring paste (carbon black: iron oxide red=1:1) are mixed and stirred for 40 min, then vacuumized for 10 min, then stirred for a further 10 min under vacuumized conditions, thus obtaining the PVC slurry.
2) Preparation of PVC skin: the PVC slurry prepared in step 1) is spread onto release paper, baked for 2 min in oven conditions of 220° C. and 1500 rpm, and after cooling, a skin is peeled off the release paper, thus obtaining the PVC skin.

### Comparative Example 1

A PVC skin is prepared according to the following steps:
1) Preparation of PVC slurry: 50 parts by weight of PVC resin (degree of polymerization 1300, particle size 1-5 μm), 1 part by weight of stabilizer (calcium stearate), 50 parts by weight of plasticizer (trioctyl trimellitate) and 2 parts by weight of coloring paste (carbon black: titanium white=1:3) are mixed and stirred for 40 min, then vacuumized for 10 min, then stirred for a further 10 min under vacuumized conditions, thus obtaining the PVC slurry.
2) Preparation of PVC skin: the PVC slurry prepared in step 1) is spread onto release paper, baked for 2 min in oven conditions of 220° C. and 1500 rpm, and after cooling, a skin is peeled off the release paper, thus obtaining the PVC skin.

### Comparative Example 2

A PVC skin is prepared according to the following steps:
1) Preparation of PVC slurry: 50 parts by weight of PVC resin (degree of polymerization 1300, particle size 1-5 μm), 1 part by weight of stabilizer (calcium stearate), 50 parts by weight of plasticizer (trioctyl trimellitate), 5 parts by weight of aliphatic hydrocarbon (Isopar V, purchased from ExxonMobil, boiling range 270° C.-311° C.), 2 parts by weight of wetting dispersant (polyester) and 2 parts by weight of coloring paste (carbon black: titanium white=1:3) are mixed and stirred for 40 min, then vacuumized for 10 min, then stirred for a further 10 min under vacuumized conditions, thus obtaining the PVC slurry.
2) Preparation of PVC skin: the PVC slurry prepared in step 1) is spread onto release paper, baked for 2 min in oven conditions of 220° C. and 1500 rpm, and after cooling, a skin is peeled off the release paper, thus obtaining the PVC skin.

### Comparative Example 3

A PVC skin is prepared according to the following steps:
1) Preparation of PVC slurry: 50 parts by weight of PVC resin (degree of polymerization 1300, particle size 1-5 μm), 1 part by weight of stabilizer (calcium stearate), 50 parts by weight of plasticizer (trioctyl trimellitate) and 5 parts by weight of aliphatic hydrocarbon (Isopar E, purchased from ExxonMobil, boiling range 114° C.-139° C.) are mixed and stirred for 40 min, then vacuumized for 10 min, then stirred for a further 10 min under vacuumized conditions, thus obtaining the PVC slurry.
2) Preparation of PVC skin: the PVC slurry prepared in step 1) is spread onto release paper, baked for 2 min in oven conditions of 220° C. and 1500 rpm, and after cooling, a skin is peeled off the release paper, thus obtaining the PVC skin.

### Comparative Example 4

A PVC skin is prepared according to the following steps: 1) Preparation of PVC slurry: 50 parts by weight of PVC resin (degree of polymerization 1300, particle size 1-5 μm), 1 part by weight of stabilizer (calcium stearate), 50 parts by weight of plasticizer (trioctyl trimellitate), 5 parts by weight of aliphatic hydrocarbon (Isopar E, purchased from ExxonMobil, boiling range 114° C.-139° C.) and 2 parts by weight of coloring paste (carbon black: titanium white=1:3) are mixed and stirred for 40 min, then vacuumized for 10 min, then stirred for a further 10 min under vacuumized conditions, thus obtaining the PVC slurry.
2) Preparation of PVC skin: the PVC slurry prepared in step 1) is spread onto release paper, baked for 2 min in oven conditions of 220° C. and 1500 rpm, and after cooling, a skin is peeled off the release paper, thus obtaining the PVC skin.

### Comparative Example 5

A PVC skin is prepared according to the following steps:
1) Preparation of PVC slurry: 50 parts by weight of PVC resin (degree of polymerization 1300, particle size 1-5 μm), 1 part by weight of stabilizer (calcium stearate), 50 parts by weight of plasticizer (trioctyl trimellitate), 10 parts by weight of aliphatic hydrocarbon (Isopar E, purchased from ExxonMobil, boiling range 114°° C.-139° C.) and 2 parts by weight of coloring paste (carbon black: titanium white=1:3) are mixed and stirred for 40 min, then vacuumized for 10 min, then stirred for a further 10 min under vacuumized conditions, thus obtaining the PVC slurry.
2) Preparation of PVC skin: the PVC slurry prepared in step 1) is spread onto release paper, baked for 2 min in oven conditions of 220° C. and 1500 rpm, and after cooling, a skin is peeled off the release paper, thus obtaining the PVC skin.

### Comparative Example 6

A PVC skin is prepared according to the following steps:
1) Preparation of PVC slurry: 50 parts by weight of PVC resin (degree of polymerization 1300, particle size 1-5 μm), 1 part by weight of stabilizer (calcium stearate), 50 parts by weight of plasticizer (trioctyl trimellitate), 2 parts by weight of wetting dispersant (polyester) and 2 parts by weight of coloring paste (carbon black: titanium white=1:3) are mixed and stirred for 40 min, then vacuumized for 10 min, then stirred for a further 10 min under vacuumized conditions, thus obtaining the PVC slurry.
2) Preparation of PVC skin: the PVC slurry prepared in step 1) is spread onto release paper, baked for 2 min in oven conditions of 220° C. and 1500 rpm, and after cooling, a skin is peeled off the release paper, thus obtaining the PVC skin.

### Comparative Example 7

A PVC skin is prepared according to the following steps:
1) Preparation of PVC slurry: 50 parts by weight of PVC resin (degree of polymerization 1300, particle size 1-5 μm), 1 part by weight of stabilizer (calcium stearate), 50 parts by weight of plasticizer (trioctyl trimellitate), 7 parts by weight of wetting dispersant (polyester) and 2 parts by weight of coloring paste (carbon black: titanium white=1:3) are mixed and stirred for 40 min, then vacuumized for 10 min, then stirred for a further 10 min under vacuumized conditions, thus obtaining the PVC slurry.
2) Preparation of PVC skin: the PVC slurry prepared in step 1) is spread onto release paper, baked for 2 min in oven conditions of 220° C. and 1500 rpm, and after cooling, a skin is peeled off the release paper, thus obtaining the PVC skin.

### Performance Tests

The PVC slurries and PVC skins obtained in Examples 1-6 and Comparative examples 1-7 were subjected to the following performance tests separately.
1. Odor: Samples of area 200 cm² were taken from fresh samples of the PVC skins and subjected to odor testing according to standard PV3900 C3. The test results are listed in Table 1, with the odor characteristics of the materials being classified as follows according to the specifications of the standard:
level 1—no odor;
level 2—there is odor, but no disturbing odor;
level 3—there is obvious odor, but no disturbing odor;
level 4—there is disturbing odor;
level 5—there is strong disturbing odor;
level 6—there is unbearable odor.
2. Thermal aging: PVC skin samples were subjected to thermal aging tests according to standard VW50132. The test temperature was 120° C. and the duration was 168 h, and the degree of thermal aging was indicated by color change value. The test results are listed in Table 1.
3. Volatile organic compounds (VOC): The VOC of PVC skin samples was tested according to standard VDA278. The test results are listed in Table 1.
4. Viscosity: After leaving the PVC slurry to stand for 3 days, the viscosity of the PVC slurry was tested at 23° C. and a shear rate of 0.83 s⁻¹. The requirement for the viscosity needed to produce PVC skin is 2-20 Pas, with the preferred viscosity being 8-16 Pa*s. The test results are listed in Table 1.
5. Slurry stability: After leaving the PVC slurry to stand for 2 weeks, observations are performed to determine the extent of separation into layers and color separation/mottling; separation into layers is mainly caused by settlement of resin in the PVC slurry, while color separation/mottling is mainly caused by poor dispersion of pigment. The test results are listed in Table 1.

TABLE 1
Performance test results

| | | | | Viscosity | |
|---|---|---|---|---|---|
| | | | | after 3 | |
| | Odor | Thermal | VOC | days | Slurry stability |
| | level | aging | ppm | Pa*s | (two weeks) |
| Example 1 | 4 | 1.15 | 245 | 13.3 | Stable |
| Example 2 | 4 | 1.08 | 187 | 9.8 | Stable |
| Example 3 | 4 | 1.19 | 203 | 10.4 | Stable |
| Example 4 | 4 | 1.02 | 192 | 15.2 | Stable |
| Example 5 | 4 | 1.18 | 178 | 17.8 | Stable |
| Example 6 | 4 | 1.21 | 249 | 14.5 | Stable |
| Comparative | 4 | 1.29 | 202 | 40.3 | Separation into |
| example 1 | | | | | layers, color |
| | | | | | separation/mottling |
| Comparative | 4.5 | 1.27 | 2158 | 22.8 | Stable |
| example 2 | | | | | |
| Comparative | 4 | — | 215 | 15.3 | Separation into |
| example 3 | | | | | layers |
| Comparative | 4 | 1.12 | 229 | 22.1 | Separation into |
| example 4 | | | | | layers, color |
| | | | | | separation/mottling |
| Comparative | 4.5 | 1.05 | 879 | 15.7 | Separation into |
| example 5 | | | | | layers, color |
| | | | | | separation/mottling |
| Comparative | 4 | 1.22 | 223 | 25.7 | Stable |
| example 6 | | | | | |
| Comparative | 4 | 1.3 | 250 | 24.9 | Stable |
| example 7 | | | | | |

Performance test results are obtained according to Table 1:

The PVC slurries obtained in Examples 1-6 according to the present invention have low viscosity (lower than 20 Pa*s) suitable for skin production and good slurry stability, and the odor, thermal aging and VOC of the PVC skins produced therefrom remain at a level close to that of Comparative example 1 in which no viscosity reducer is added; that is to say, the addition of the viscosity reducer according to the present invention does not affect the odor, thermal aging or VOC of the finished product, which are key properties.

In contrast to Example 1, Comparative example 1 had no viscosity reducer added; as a result, the slurry obtained had very high viscosity and was unstable, so cannot be used to prepare a satisfactory PVC skin. Comparative example 2 used an aliphatic hydrocarbon solvent with a boiling point higher than 250° C.; as a result, the odor of the PVC skin worsened and its VOC content increased. In comparative examples 3 and 4, only an aliphatic hydrocarbon solvent with a boiling point of 100° C.-250° C. was added as a viscosity reducer; not only was there a reduction in viscosity, the PVC skin finished product was also able to maintain odor and VOC. However, with the addition of coloring paste in Comparative example 4, the lack of a wetting dispersant resulted in worsened slurry viscosity and stability compared with Comparative example 3 in which no coloring paste was added. In Comparative example 5, in order to reduce the high viscosity caused by the coloring paste, a large amount (exceeding the range defined in the present invention) of an aliphatic hydrocarbon solvent with a boiling point of 100° C.-250°° C. was added; although this reduced the slurry viscosity, it caused both the odor and VOC of the PVC skin to worsen. In Comparative examples 6 and 7, only a wetting dispersant was added as a viscosity reducer; this caused the slurry to have good stability, but the viscosity reduction effect was limited, and unable to meet production requirements.

It will be understood that the above embodiments are merely exemplary embodiments used to illustrate the principles of the present invention, and the present invention is not limited thereto. Various modifications and improvements can be made by a person skilled in the art without departing from the spirit and essence of the present invention, and these modifications and improvements are also considered as falling within the protection scope of the present invention.

1. A PVC slurry for manufacturing a PVC artificial leather, comprising:
a PVC resin, a plasticizer, a viscosity reducer and a stabilizer;
wherein the viscosity reducer comprises a wetting dispersant and an aliphatic hydrocarbon solvent with a boiling point in the range of 100° C.-250° C.

2. The PVC slurry of claim 1, wherein the PVC resin comprises a high-viscosity PVC resin with a degree of polymerization of 1300-1600 and a particle size of 1-10 μm, or consists of the high-viscosity PVC resin.

3. The PVC slurry of claim 1, wherein the PVC slurry comprises 30-60 parts by weight of PVC resin and 30-60 parts by weight of plasticizer, wherein the ratio of contents of the PVC resin and plasticizer is in the range of 1:2-2:1.

4. The PVC slurry of claim 1, wherein based on the total weight of the PVC resin and plasticizer being 100 parts by weight, the PVC slurry comprises 2-10 parts by weight of viscosity reducer.

5. The PVC slurry of claim 4, wherein based on the total weight of the PVC resin and plasticizer being 100 parts by weight, the viscosity reducer comprises 1-8 parts by weight of the aliphatic hydrocarbon solvent and 0.5-2 parts by weight of the wetting dispersant.

6. The PVC slurry of claim 1, wherein the wetting dispersant is a carboxylate derivative, preferably one or more of a polyester dispersant, an acrylate copolymer and a polyurethane dispersant.

7. The PVC slurry of claim 1, wherein the aliphatic hydrocarbon solvent is one or more of an alicyclic hydrocarbon with a chain length of C8-C13, a branched aliphatic hydrocarbon with a chain length of C8-C13 and a straight-chain aliphatic hydrocarbon with a chain length of C8-C13.

8. The PVC slurry of claim 1, wherein based on the total weight of the PVC resin and plasticizer being 100 parts by weight, the PVC slurry comprises 1-10 parts by weight of stabilizer.

9. The PVC slurry of claim 1, wherein based on the total weight of the PVC resin and plasticizer being 100 parts by weight, the PVC slurry comprises 1-5 parts by weight of coloring paste.

10. The PVC slurry of claim 1, wherein the PVC slurry is incorporated into A PVC artificial leather, comprising a PVC skin layer prepared from the PVC slurry.
